(19) United States
(12) Patent Application Publication
(10) Pub. No.: US 2021/0240858 A1
(43) Pub. Date: Aug. 5, 2021

(54) SYSTEM FOR PROTECTING INTEGRITY OF TRANSACTION DATA

(71) Applicant: CENTRICA PLC, Windsor, Berkshire (GB)

(72) Inventors: Ghislain Landry TSAFACK CHETSA, Windsor, Berkshire (GB); Adhikari A U D P WIJESUNDERA, Windsor, Berkshire (GB); Zahir-Abbas SUMAR, Windsor, Berkshire (GB)

(21) Appl. No.: 17/053,582

(22) PCT Filed: May 7, 2019
(86) PCT No.: PCT/GB2019/051256

§ 371 Date: Nov. 6, 2020

(30) Foreign Application Priority Data
May 9, 2018 (GB) 1807568.9

(51) Int. Cl. G06F 21/64; H04L 9/32; G06F 16/23; G06F 21/60; G06Q 20/40; G06Q 50/06

(52) U.S. Cl. CPC G06F 21/64; H04L 9/3239; G06F 16/2379; H04L 2209/38; G06Q 20/401; G06Q 50/06; G06Q 2220/00; G06F 21/602

(57) ABSTRACT

System for controlling energy supply and processing energy transactions A method of securing data stored in a data storage system using a blockchain is disclosed. The data storage system may be separate from the blockchain. The method comprises: receiving, at a storage interface, data to be stored in the data storage system; computing validation data for validating integrity of the data; creating a storage record comprising the data and writing the storage record to the data storage system; and creating a validation record comprising the validation data and writing the validation data to the blockchain. Also disclosed are a method for validating data using validation data stored in a blockchain, and a method of controlling an energy supply system using a control system and control information for the energy supply system stored in a blockchain.

The present disclosure relates to systems and methods for controlling energy supply and processing energy supply transactions, for example in the context of an electric vehicle charging system. The disclosure further relates to data processing and storage mechanisms which are more widely applicable beyond the context of energy supply.

In recent years, electric vehicles have become viable alternatives to conventional vehicles, and their adoption is expected to increase significantly in the near future. However, lengthy charging cycles and comparatively limited range means vehicles need to be charged frequently and for long durations. This creates particular challenges in providing a suitable charging infrastructure, for example to ensure that supplied energy is accurately controlled, metered and accounted for. Similar problems also arise more widely in the energy industry, given developments such as the increased use of smart meters providing high-resolution consumption data and increased competition and deregulation in the energy market. Increased requirements for transparency and cooperation between providers and consumers also present challenges in the secure management of data.

The present invention seeks to alleviate some of the above problems.

Accordingly, in a first aspect of the invention, there is provided a method of controlling an energy supply system using a control system, wherein the energy supply system is connectable to an energy consumer to supply energy to the energy consumer, the method comprising: receiving a supply request from a user device at the control system; accessing, by the control system, control information for the energy supply system stored in a blockchain; determining, by the control system, whether to allow (e.g. grant or authorise) the supply request based on the control information; and in dependence on the determination, enabling, by the control system, supply of energy by the energy supply system to the energy consumer.

The term “blockchain” preferably refers to a distributed storage system comprising a plurality of cryptographically linked storage blocks. Cryptographic links between blocks are typically in the form of hashes, where a given block comprises one or more hashes of one or more other blocks of the blockchain. A hash of a block may be a hash of the entire block or of a particular part thereof, and may be generated using any suitable cryptographic hash function. Typically, each block (except a first block) comprises a hash of a preceding block in the blockchain, thus forming the blocks into an ordered chain.

The energy consumer is typically in the form of a device, apparatus or machine adapted to consume energy. The energy supply system is preferably an electrical energy supply system, preferably comprising an electrical charging point. The energy consumer may thus be an electrical device adapted to use and/or store electrical energy (e.g. using one or more rechargeable batteries). The energy supply system may comprise an electrical charging point for electric vehicles.

The control information may comprise a status indicator indicating a status (e.g. operational state) of the energy supply system, the status preferably selected from a group comprising at least an available status, and an unavailable status. The available status may e.g. indicate that the supply system is currently idle/not in use, and available for use. The unavailable status may e.g. indicate that the supply system is currently active/operational/in use (and/or could indicate that the supply system is inactive, offline, faulty etc.) Enabling supply of energy preferably comprises controlling switching means at the energy supply system to selectively connect the energy supply system to an energy source.

Preferably, the control system is connected to the energy supply system via a communications network, and wherein the enabling step comprises communicating, by the control system, control information to the energy supply system via the network. The enabling step preferably comprises storing, by the control system, further control information in the blockchain indicating that energy supply from the energy supply system is to be activated.

The method may comprise determining whether a status indicator in the control information indicates an available status, and in response, storing an updated status indicator for the energy supply system in the blockchain, the updated status indicator indicating an unavailable (active/operational/in use) status, e.g. to signal to the energy supply system that it should transition to an active/operational status. The method may comprise retrieving, by a control interface associated with the energy supply system, the further control information from the blockchain to determine whether energy supply is to be activated, and activating the supply of energy in dependence on the retrieved control information.

The method may comprise controlling switching means at the energy supply system to selectively connect the energy supply system and/or energy consumer to an energy source in dependence on the control information retrieved from the blockchain. Preferably, the method comprises periodically polling the control information stored in the blockchain by the control interface. Retrieving the control information may comprise sending a request for the control information to a node of the blockchain via a communications network and receiving a response with the control information. The control information for the energy supply system is preferably stored in the blockchain together with, and/or is retrieved based on, an identifier of the energy supply system.

The control information may include user authorisation data. Determining whether to allow the supply request may comprise determining whether a user identified based on the request is authorised to use the energy supply system based on the authorisation data. The authorisation data may comprise reservation data indicating a reservation to use the energy supply system, e.g. at a specified time. Thus, the enabling step may comprise storing control information specifying a time slot reservation for the energy supply system in the blockchain. The method may then comprise retrieving the control information comprising the time slot reservation by a control interface of the energy supply system, and activating energy supply based on the time slot reservation, preferably at a time and/or for a duration specified by the time slot reservation.

Preferably, the control system comprises one or more processing nodes, at least one of the processing nodes functioning as a blockchain node of the blockchain. As used herein, the terms “node”, “processing node”, “blockchain node” or similar preferably refer to any computing entity able to perform data processing. Such a computing entity could be a standalone computer device (e.g. server/personal computer) or a component within a computer device (e.g. a process/thread/application etc.)

The control system preferably comprises a server module for receiving requests from user devices via a network.

Preferably, the method further comprises, in response to the request, storing information for an energy supply transaction in one or both of: the blockchain; and a further data storage domain separate from the blockchain, the further data storage domain preferably comprising one of: a second blockchain, and a database system. The method may comprise storing a first data record for the energy supply transaction in the further data storage domain, and a second data record for the energy supply transaction in the blockchain. The method preferably comprises computing a validation hash based on data of the first data record, and wherein the second data record comprises the validation hash. The second data record may comprise a subset of the data of the first data record.

In a further aspect of the invention, which may be combined with the above aspect, there is provided a charging system for charging an electrical device, comprising: a charging device connectable to the electrical device for charging the electrical device; a switch for selectively connecting the charging device to an electricity supply; and a controller for controlling the switch; wherein the controller is configured to: connect to a blockchain node of a blockchain storing control data; retrieve control data for the charging system from the blockchain via the blockchain node; and control the switch in dependence on the retrieved control data to selectively connect the charging device to the electricity supply and thereby enable charging of the electrical device. The blockchain node preferably comprises a remote processing node connected to the controller via a communications network. The charging system may be an electric vehicle (EV) charging station, and the electrical device may be an electric vehicle. The charging system may further be configured to perform or participate in a method as set out above.

In a further aspect of the invention (which may be combined with any of the above-described aspects), there is provided a control system for controlling an energy supply device, comprising: means for receiving an energy supply request from a user device; means for accessing control information for the energy supply device stored in a blockchain; means for determining whether to allow the supply request based on the control information; and means for, in dependence on the determination, storing further control information in the blockchain for retrieval by the energy supply device to control energy supply by the energy supply device. The control information may comprise a status indicator indicating an operational status and/or availability of the energy supply device. The further control information may comprise an updated status indicator, the determining means preferably adapted, in response to determining that the energy supply device is available for use based on the status indicator, to store an updated status indicator in the blockchain indicating that the energy supply device is in use and/or should transition to an operational status. The control system may further be configured to perform or participate in any method as set out above.

In a further aspect of the invention (which may be combined with any of the above-described aspects), there is provided a method of securing data stored in a data storage system using a blockchain, wherein the data storage system is separate from the blockchain, comprising: receiving, at a storage interface, data to be stored in the data storage system; computing validation data for validating integrity of the data; creating a storage record comprising the data and writing the storage record to the data storage system; and creating a validation record comprising the validation data and writing the validation data to the blockchain.

The computing step may comprise computing a hash value based on the data, the validation data comprising the hash value. Writing the validation record to the blockchain may comprise adding the validation record to a block of the blockchain as a blockchain transaction. Preferably, the blockchain uses a consensus mechanism for addition of blocks based on one or both of: proof-of-work, and consensus of a majority of the blockchain nodes.

The data storage system may comprise a second blockchain, separate from the blockchain. Preferably, the blockchain uses a different, preferably stronger, consensus mechanism than the second blockchain. The second blockchain may use a consensus mechanism not based on proof-of work, preferably based on proof-of-stake or proof-of authority. The blockchain and the second blockchain preferably comprise respective interfaces for storage of data, each respective interface comprising code executable by the respective blockchain, preferably in the form of one or more smart contracts operating on the blockchain.

The data storage system may alternatively comprise a database system (preferably not utilising a blockchain), optionally comprising one of a relational database, a non-relational or NoSQL database, an object database, a column-oriented database, a document-oriented database, a key-value store or a graph database.

The blockchain is preferably a public blockchain, preferably wherein the data storage system is not public. Preferably, the validation records in the blockchain are accessible to one or more users not having access to the data storage system.

In a further aspect of the invention (which may be combined with any of the above-described aspects), there is provided a method of storing data in a blockchain, comprising: receiving, at a storage interface, data to be stored in the blockchain; computing validation data for validating integrity of the data; creating a storage record including the data and writing the storage record to the blockchain using a first interface of the blockchain; and creating a validation record including the validation data and writing the validation record to the blockchain using a second interface of the blockchain.

The computing step preferably comprises computing a hash value based on the data, the validation data comprising the hash value.

The first and second interfaces preferably comprise respective code executable by the blockchain. The first interface may comprise one or more first smart contracts operating on the blockchain, and the second interface may comprise one or more second smart contracts operating on the blockchain. Preferably, access to the first and second interfaces is controlled based on respective first and second access permissions. The blockchain may comprise a smart contract for managing the access permissions. The second storage interface preferably allows access to validation records by one or more users in accordance with the second access permissions where said users are prevented from accessing the first storage interface in accordance with the first access permissions. Access to the first and second interfaces may be based on separate keys (e.g. data stored via the respective interfaces may be encrypted using separate keys).

The following optional features may apply to either of the preceding two aspects of the invention.

The storage record preferably further includes the validation data. The method may comprise adding a transaction identifier to the validation record identifying the corresponding storage record. Preferably, a common transaction identifier is added to the storage record and validation record. Preferably, the storage record comprises a plurality of data elements, the method comprising adding one or more, but preferably not all, of the data elements of the storage record to the validation record. The method may comprise encrypting one or both of the storage record and the validation record before storage, optionally using different encryption keys.

The method may comprise processing an energy supply transaction, wherein the received data relates to the energy supply transaction. The data may comprise one or more of: an identifier of an energy consumer; an energy consumption value indicating an amount of energy consumed by the energy consumer; a payment amount; and a payment reference. Processing the energy supply transaction may comprise: obtaining consumption data specifying energy consumption by an energy consumer; determining a consumption value based on the consumption data and optionally based on past payment transaction data for the energy consumer; and creating payment transaction data based on the consumption value; wherein the data to be stored comprises the payment transaction data. The consumption data may be received from an energy meter associated with the energy consumer.

The method may comprise validating the storage record by a process comprising: retrieving the storage record including the stored data; re-computing the validation data from the stored data; retrieving the validation record corresponding to the storage record from the blockchain; comparing the re-computed validation data to the validation data in the retrieved validation record; and outputting a validation result in dependence on the comparison.

In a further aspect of the invention (which may be combined with any of the above-described aspects), there is provided a method of validating a storage record, comprising: retrieving the storage record including stored data from a first storage domain; computing validation data from the stored data; retrieving a validation record from a second storage domain, the second storage domain comprising a blockchain, wherein the validation record comprises validation data previously computed for the storage record; comparing the computed validation data to the validation data in the retrieved validation record; and outputting a validation result in dependence on the comparison.

In this or the previous aspect, the method may comprise outputting a validation error if the re-computed validation data does not match the validation data in the retrieved validation record and/or outputting a successful validation indication if the re-computed validation data matches the validation data.

In a further aspect of the invention (which may be combined with any of the above-described aspects), there is provided a method comprising: transferring a plurality of storage records from a first entity to a second entity, the first entity having stored the storage records in a storage domain under control of the first entity and not accessible to the second entity, the first entity further having stored validation records corresponding to the storage records in a blockchain accessible by both the first and second entities; retrieving, by the second entity, the validation records corresponding to the transferred storage records from the blockchain; and validating, by the second entity, the transferred storage records using the retrieved validation records. The first entity may have stored the storage records and corresponding validation records in accordance with any method as set out previously. Validating the storage records may be performed using a method as set out above.

The first and second entities preferably comprise respective first and second computer systems associated with respective first and second energy providers (or other organisations), and wherein the transfer and validation is performed by the second computer system associated with the second energy provider (or organisation) in response to a transfer of an energy consumer (or other customer) from the first energy provider (or organisation) to the second energy provider (or organisation).

The invention further provides a method as set out above in the first aspect of the invention, further comprising storing and/or validating data relating to energy supply transactions using any method as set above.

The invention also provides a processing device or system having means (preferably in the form of at least one processor with associated memory) for performing any method as set out herein, and one or more tangible computer-readable media comprising software code adapted, when executed on one or more data processing systems, to perform any method as set out herein.

Any feature in one aspect of the invention may be applied to other aspects of the invention, in any appropriate combination. In particular, method aspects may be applied to apparatus and computer program aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:—

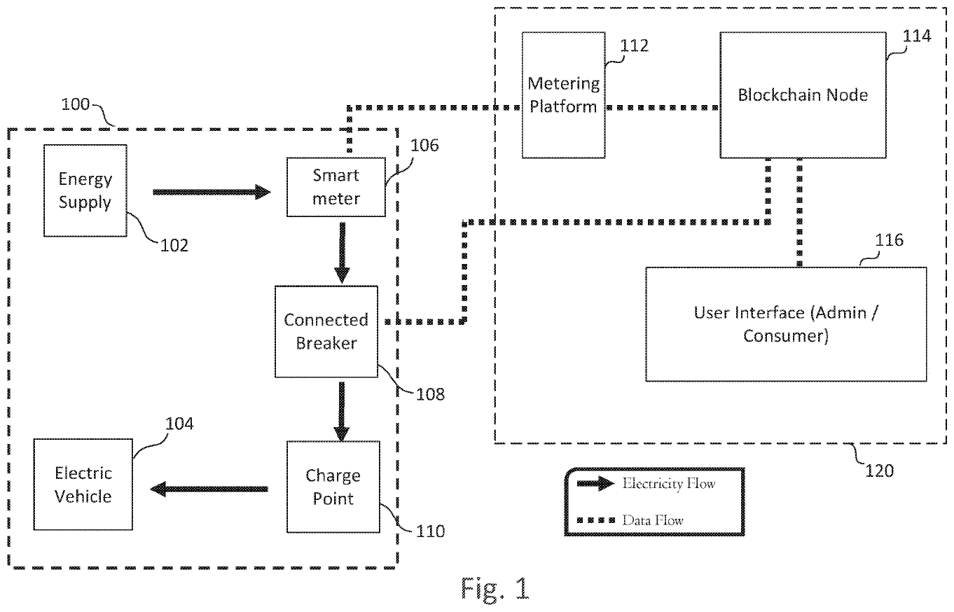

FIG. 1 illustrates a system for controlling an electric vehicle charging point;

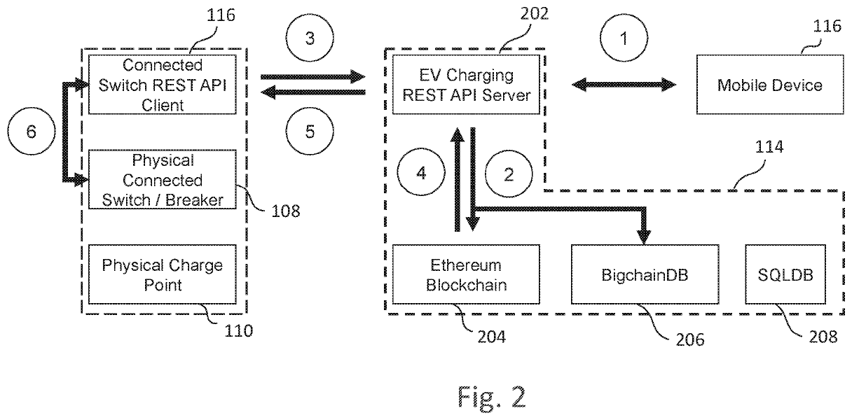

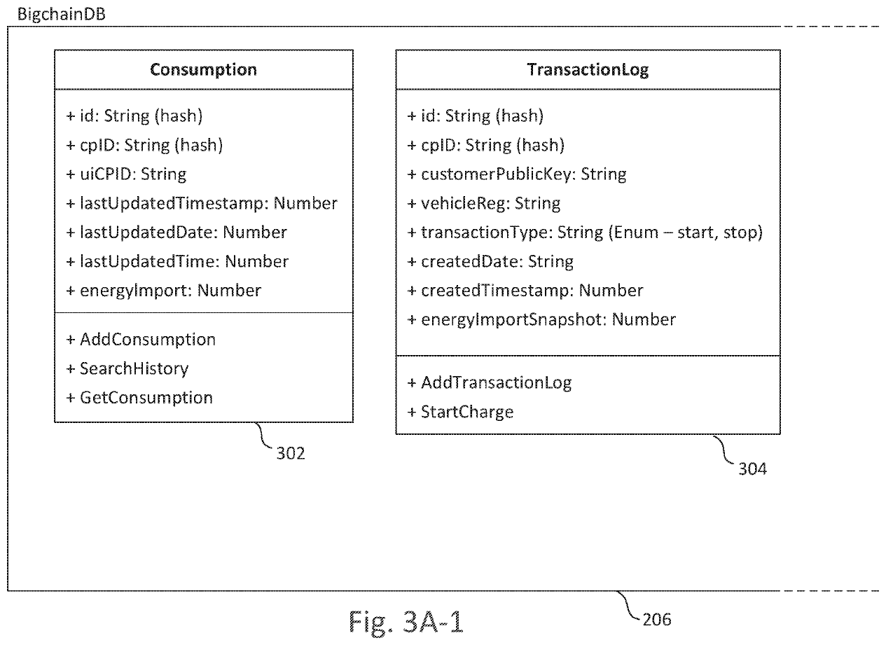

FIG. 2 illustrates hardware and software components of the control system;

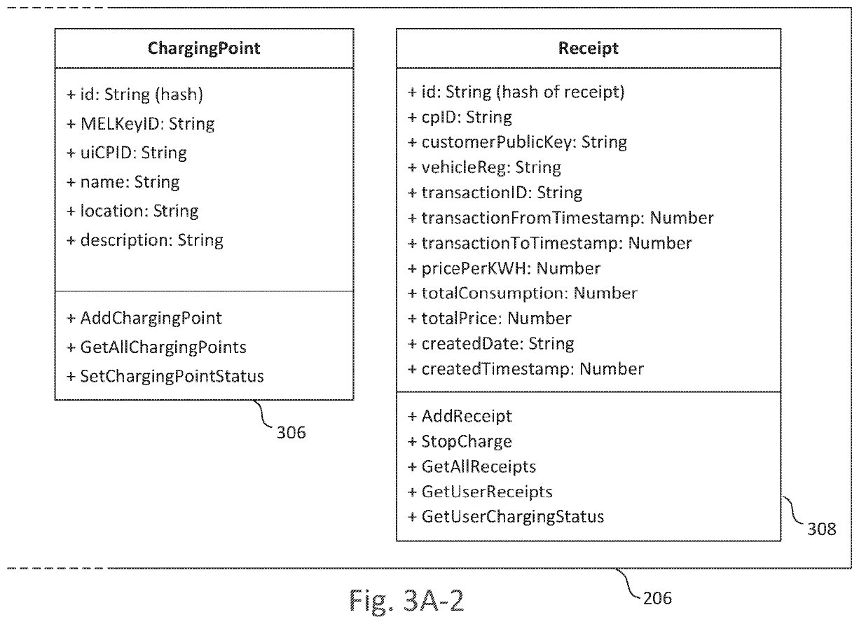

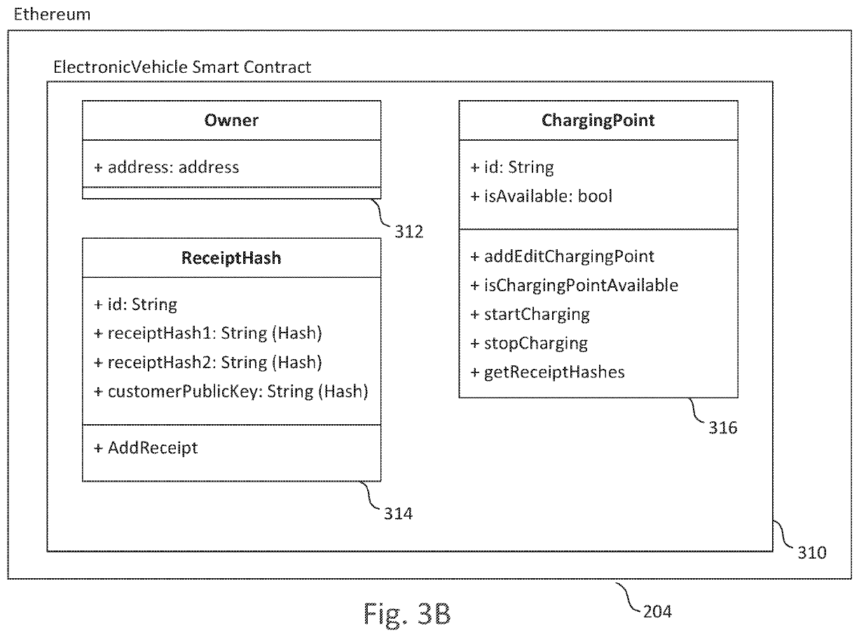

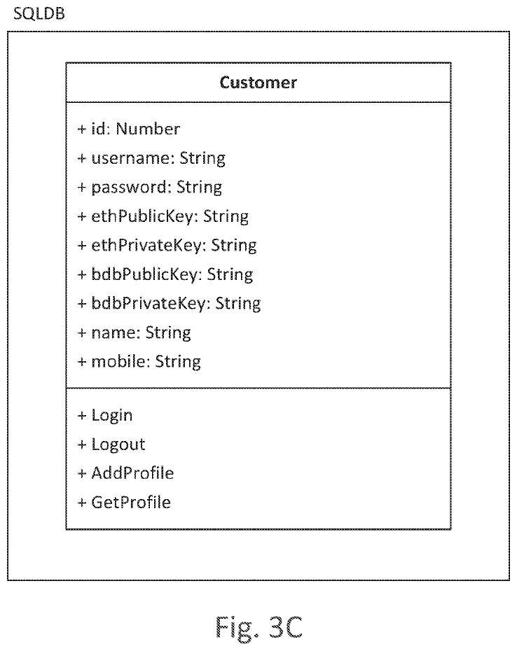

FIGS. 3A-3C are examples of data models used in the control system;

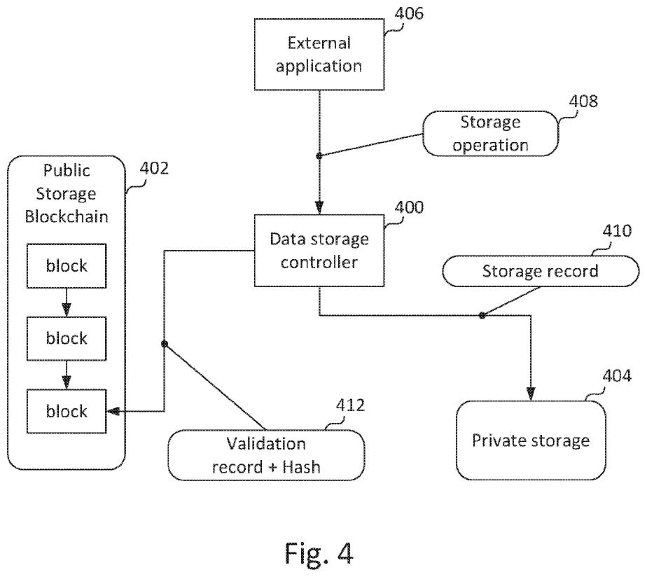

FIG. 4 illustrates a data storage mechanism;

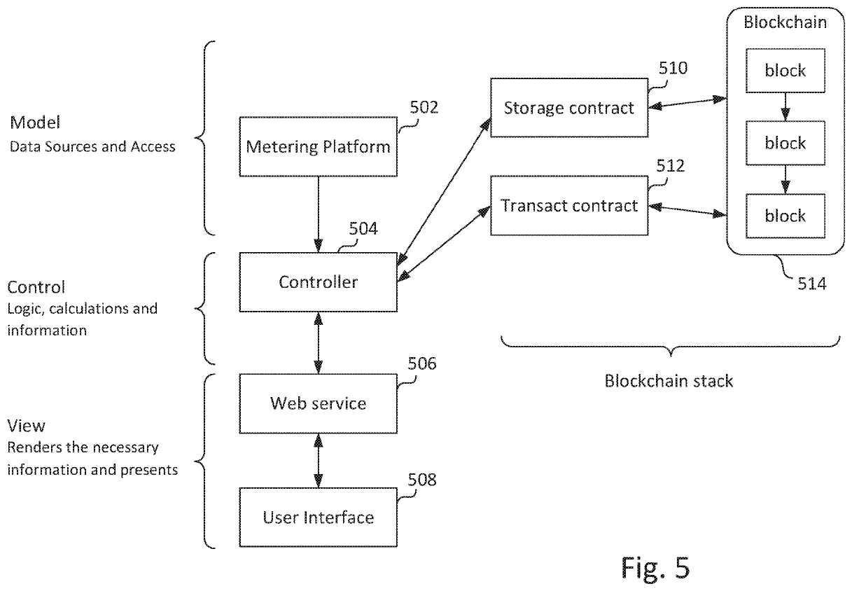

FIG. 5 illustrates a transaction processing system utilising a variant of the data storage mechanism;

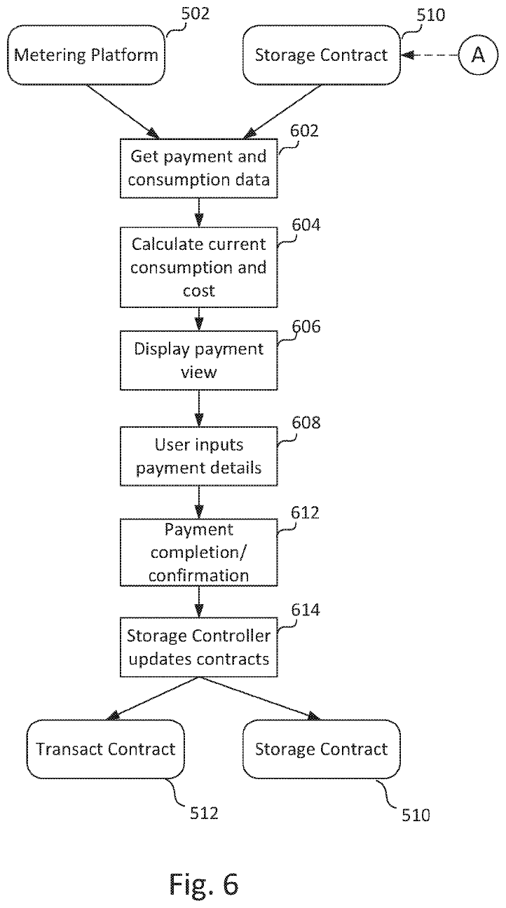

FIG. 6 illustrates processing of an energy transaction;

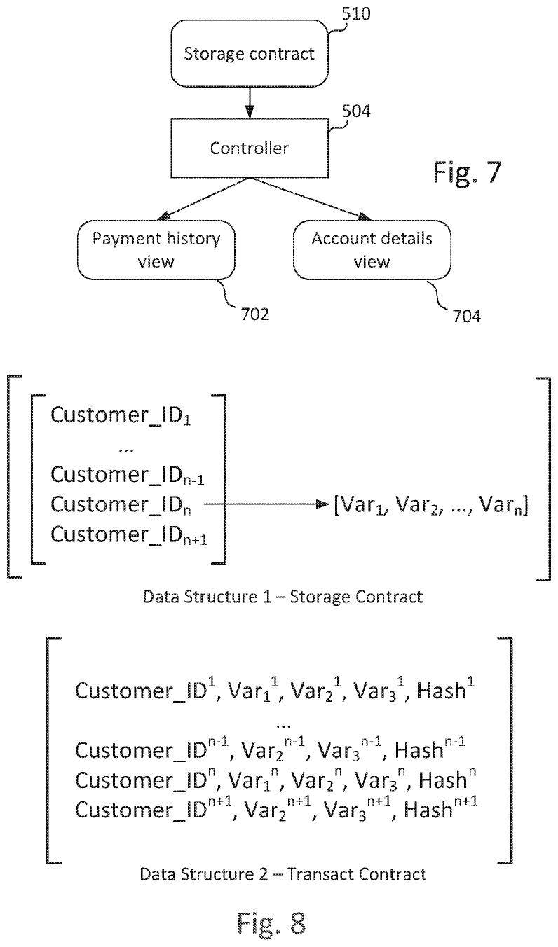

FIG. 7 illustrates ancillary functions of a transaction system;

FIG. 8 illustrates data structures for use in the transaction system;

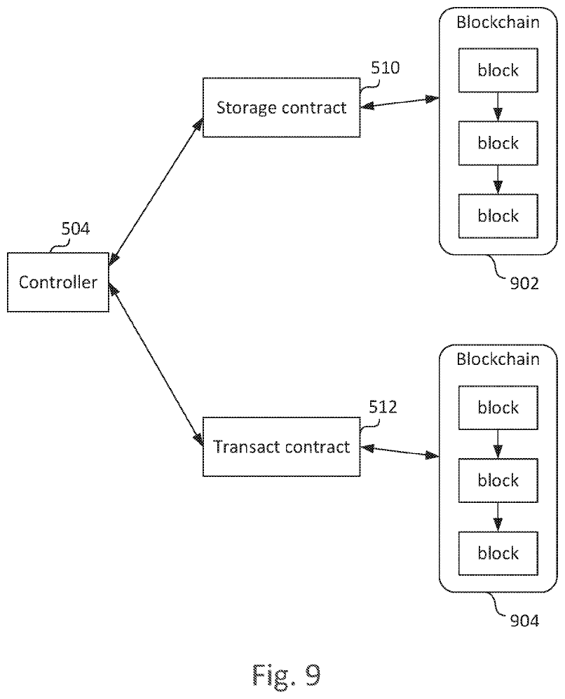

FIG. 9 illustrates a dual blockchain implementation of the data storage mechanism;

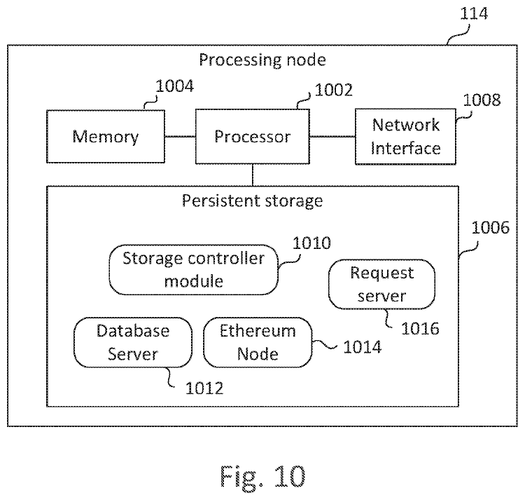

FIG. 10 illustrates a processing node suitable for implementing described techniques;

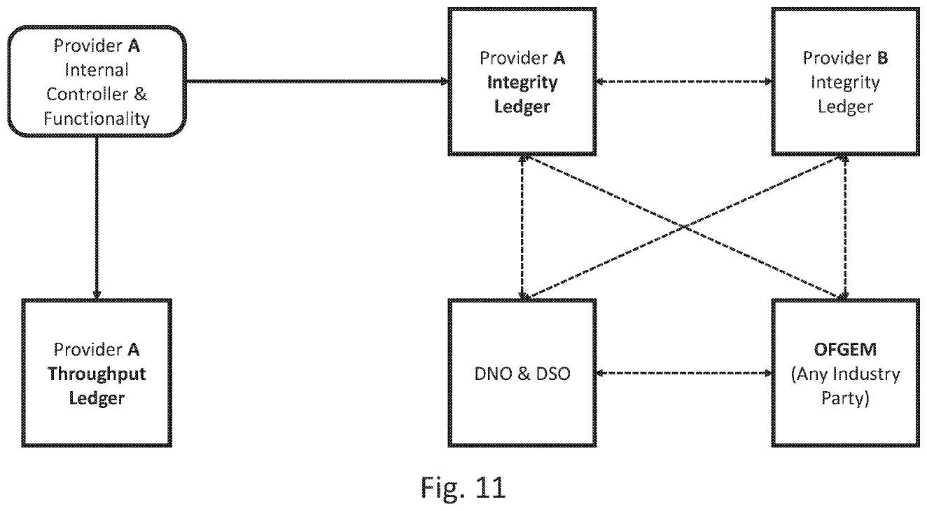

FIG. 11 illustrates inter-provider data exchange/settlement using a validation blockchain; and

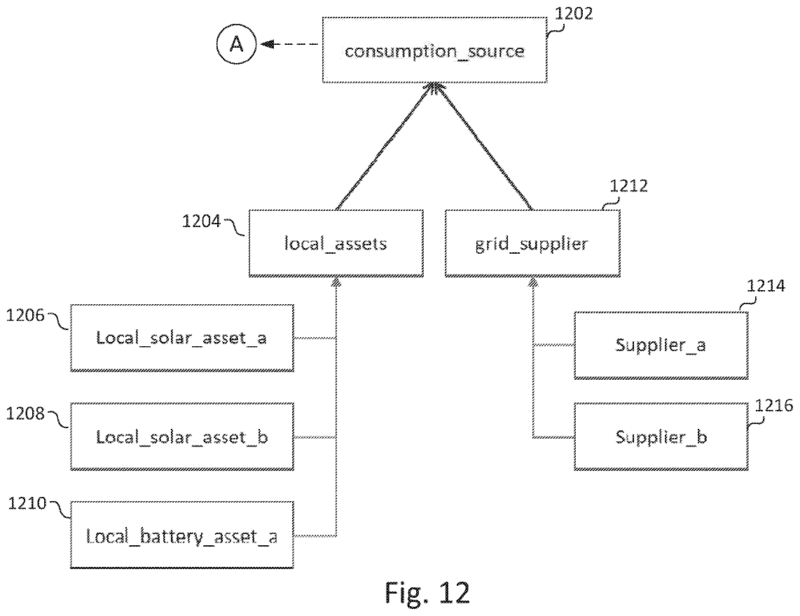

FIG. 12 illustrates a smart contract structure to support energy consumption data processing for multiple consumption sources.

### OVERVIEW

Embodiments of the invention provide systems that utilise blockchain technology to control and manage energy supply in various scenarios.

We refer to blockchain technology throughout this document and, for clarity, we define a blockchain as a data storage system comprising a set of cryptographically linked data blocks. In such a data structure, each block (except for the first block in the chain) typically contains a cryptographic hash of the previous block and may additionally contain transaction data defining blockchain transactions and/or a timestamp. A transaction may comprise data stored in the blockchain and/or may provide a record of an operation performed on the blockchain. Due to the cryptographic hashes of earlier blocks stored in each block, the blockchain is inherently resistant to modification of the data. A blockchain is also typically stored in a distributed fashion, with copies of some or all of the blocks stored simultaneously at multiple network-connected blockchain nodes, where each node may be a separate processing device, e.g. computer. Due to the chain of cryptographic hashes, data in the blockchain is generally immutable, with new transactions or data always added in a new block at the end of the chain. In this way, the blockchain may grow continuously as transactions are recorded, without data earlier in the chain being modified. While in the discussed examples a blockchain is generally formed as a linear chain of blocks, other structures, such as branching or mesh structures are possible (whilst still utilising the secure links between blocks based on cryptographic hashes), and such structures are considered to fall under the term “blockchain”.

Due to the inherent security and the distributed nature, a blockchain can provide an open, distributed ledger that can record transactions between two parties efficiently and in a verifiable and permanent way. For use as a distributed ledger, a blockchain is typically managed by a peer-to-peer network collectively adhering to a protocol for validating new blocks. Once recorded, the data in any given block cannot be altered retroactively without the alteration of all subsequent blocks, which requires collusion of the network majority.

Blockchains are secure by design and exemplify a distributed computing system with high byzantine fault tolerance. Decentralized consensus can therefore be achieved with a blockchain. While first proposed for use in the cryptocurrency “bitcoin”, blockchain technology is not limited to cryptocurrency applications.

In one example, a system is provided for controlling access to and use of charging points for electric vehicles (EVs). Access is controlled using a control system employing a blockchain to manage the status of charging points. A user wishing to use a charging point to charge their electric vehicle submits a request to the control system, for example via a mobile application. If authorised, the network remotely controls the charging point to allow charging of the vehicle.

The system is illustrated in overview in FIG. 1. The system includes an EV charging station 100, providing one or more charging points 110 to which an electric vehicle 104 can be connected to charge the vehicle. The charging point 110 is connected to an energy supply 102 (e.g. national electricity grid or local generator) via a smart meter 106 and a network-connected electrical supply switch 108. The connected switch 108 is remotely controlled by a control system 120, comprising a metering platform 112, one or more control nodes 114 and one or more user interface device(s) 116. Note that while a single charging station 100 is shown, in practice the system could include any number of such charging stations connected to one or more control nodes 114.

To use the system, the user physically connects the electric vehicle 104 to the charging point 110 (e.g. by charging cable). The charging point is initially disconnected from supply 102 by the switch 108. The user interacts with the control node 114 from a user device 116, via a suitable user interface, to request access to the charging point. The user interface may be provided as a mobile device application (e.g. running on a smartphone or tablet computer), as a web application running on a mobile device or other computer terminal, as a voice app or skill on a voice-controlled device or in any other suitable manner.

The user submits a request to access the charging point via the user device/interface 112 and the request is transmitted to the control node 114. The control node checks whether access is to be granted (e.g. whether the user is authorised, whether the charging point is available for use etc.) and if so, transmits a control information to the connected switch 108 to connect the charging point to the supply. The switch is then activated in response to the control information, thereby connecting the charging point 110 to the supply 102, allowing the electric vehicle to draw electrical power from the supply 102. The consumed electricity is measured by a smart meter 106, which reports the usage to a metering platform 112, where consumption data is aggregated and stored. The metering platform provides consumption data (e.g. in the form of aggregate consumption of particular charging points over a given time period) to the control node 114 on request (e.g. when processing charging transactions) or proactively (e.g. at periodic intervals).

The control system uses a blockchain for storing certain data, including control data, and for communicating control data with the charging station 100. The control node 114 therefore functions as a blockchain node for the blockchain. As such, control node 114 stores copies of data blocks of the blockchain, and is able to read data from the blockchain and submit blockchain transactions to the blockchain, including storing data on the blockchain. While in this example a single control node is shown for illustrative purposes, there will typically be multiple blockchain nodes participating in the blockchain, and multiple such nodes could implement the control functions as described herein. Since a blockchain provides a distributed data store, by its nature, information added by one node is available to other nodes on the chain.

FIG. 2 illustrates in more detail a software architecture for supporting EV charging transactions and the steps involved in processing such a transaction.

The control node is shown in FIG. 2 collectively as element 114, which includes several subcomponents, including a number of separate storage subsystems.

A main database 206 stores all consumption, transaction, charge point status and receipt data. In an embodiment, this is implemented as a BigchainDB database (BigchainDB is a scalable, decentralised and distributed database based in part on blockchain technologies). Additionally, a conventional relational database 208 (e.g. SQL-based) may be provided to store to store other information for the operator of the EV charging system, such as customer data for login & registration. However, main database 206 could similarly be a conventional relational database, object database or any other storage framework and databases 206 and 208 could also be combined.

An Ethereum blockchain 204 stores control data, including information on the status of charging points in the system. Additionally, the blockchain may hold a subset of relevant transaction data from the main database 206 for purpose of ensuring data integrity as will be described in more detail later.

In addition to data storage subsystems, the node 114 also runs an EV charging server module 202 (here implemented as a REST API server) for processing EV charging transactions by interacting with user devices (e.g. mobile device 116) and charging stations.

Consumption data received from the metering platform 112 is stored by the control node in the database 206 and is used to process charging transactions. Consumption data may additionally or alternatively be recorded in the blockchain.

In this example, the components of node 114 are all hosted in a single node in a suitable cloud computing platform such as Azure. However, individual components could alternatively be distributed across several distinct computing nodes (locally or remotely connected to each other). For example, the server module 202, blockchain node 204 and database systems 206, 208 could be provided on separate computing devices.

FIG. 3A illustrates an example data model for the main database 206. The database stores information about energy consumptions 302 (i.e. energy consumed at different charging points, as measured by the meters and recorded by the metering platform 112), a transaction log 304 of charging start/stop operations, information 306 on the charging points available in the system (including e.g. the location and name of each charging point), and information 308 on completed user transactions (e.g. as payment “receipts”, specifying energy consumed, charging rate, payment amount etc.)

FIG. 3B illustrates an example data model for data stored in the Ethereum blockchain 204. The blockchain 204 includes a smart contract 310 providing an interface for writing data to/reading data from the blockchain. Data stored includes owner information 312, receipt records 314 corresponding to completed charging transactions and charging point status information 316.

The receipt records 314 include hashes of the more detailed information stored in the “receipt” records 308 of FIG. 3A. In preferred embodiments, the main database 316 is typically a private system managed securely e.g. by the service operator of the EV charging system, whereas the blockchain 204 is “public”, in the sense that it may not be wholly under control of that same organisation (and so other organisations or individuals may run nodes on the same blockchain and access the data contained in it). The receipt hashes recorded in the public blockchain 204 as part of receipt records 314 can be used to ensure integrity of the privately held data in database 206. This use of a blockchain to ensure the integrity of information in a secondary (possibly private) storage system will be described in more detail below.

The charging point status information 316 records the current status of given charging points, specifying at least an identifier of the charging point, and a status indicator indicating whether the charging point is currently available for use or not. In the example this is a Boolean flag simply indicating “available” or “unavailable” status (the later could indicate the charging point is in use, out of service, faulty etc.). In other examples, the status information may encode more than two possible statuses, e.g. to indicate “fault” and/or “offline” statuses in addition to “busy” and “available” statuses. The status information is used not just for information purposes but also as control information for controlling the charging point, as described further below.

The charging point status is associated with a number of operations, including an “isChargingPointAvailable” operation for reading the status to check availability and “start charging” and “stop charging” operations, which modify the charge point status to unavailable/available respectively.

The data stored in the conventional relational database 208 is illustrated in FIG. 3C and includes basic customer information, including username, password, name and contact information (e.g. mobile telephone number), and public/private keys for the customer for the Ethereum blockchain and BigchainDB database. The database preferably provides appropriate security measures to protect this information (alternatively, a separate key management solution may be employed).

Referring back to FIG. 2, the processing of a charging transaction follows the steps set out below.

At (1), the user initiates “Start Charging” or “Stop Charging” commands via the user interface, e.g. using a mobile device application on a smartphone. The request is sent to the EV Charging Server 202. The request includes identifying information identifying the charging point. This identifier could be acquired e.g. by the user manually inputting an identifier into the charging application, by acquiring an image of a QR code or similar visual encoding of the identifier displayed at the charging point using a camera of the user's device, or the identifier could be wirelessly transmitted from the charging point to the user device (e.g. via NFC, Near Field Communication or RFID, radio-frequency identification, or the like.)

At (2), the Start/Stop charge request from the user results in a change to the state of the Charging Point in the Ethereum smart contract as well as entering separate records in BigchainDB both for Start and Stop events.

When receiving a “Start” request, the charging point state is first checked before the user can use it for charging. If the charging point is available, then the user can start charging and the charging point status is updated to be “Busy”. Otherwise, if the charging point status is already “Busy” or otherwise not available, then the user request is rejected.

At (3) the REST API client 116 associated with the connected switch 108 checks the charging point status by sending a GET request to the EV Charging Server 202 periodically, e.g. every second. A charging point identifier is passed along with the request. At (4), the EV Charging Server then retrieves the particular charging point's operational status using the identifier from the smart contract in the Ethereum blockchain. At (5), the EV Charging Server returns the status of the charging point to the client 116.

At (6), the client 115 turns on/off the connected switch 108 and thereby activates or interrupts supply of power to the charging point based on the status returned by the charging server.

The described approach thus involves asynchronous control of the charging point via the blockchain—the charging point periodically polls its own status in the blockchain (via server 202) to determine whether it is busy or idle, and switches on/off the connected switch 108 accordingly, with no direct knowledge of the user requests received and processed at the server. If the received status indicator changes from a “busy” status to an “idle/available” status, the switch is disconnected, whereas if the status indicator changes from “idle/available” to “busy”, the switch is activated to connect the charging point to the supply. Thus, the status information recorded on the blockchain acts as a control signal to the connected switch 108.

The server 202, on the other hand simply processes user requests based on the status information recorded in the blockchain, updating the status as needed to control the supply at the charging points. Note that in this arrangement, the blockchain node updating the status on the blockchain (here 204) following a user request need not be the same blockchain node from which the connected switch client 116 subsequently acquires the updated status information (given the distributed nature of the blockchain). Thus, the charging station could access a blockchain node remote from control node 114 or could include its own blockchain node. However, in alternative arrangements the server could send specific activation/deactivation control messages directly to the charging point in response to user requests.

In a variation of the described approach, the server determines whether a given user may use the charging point not only based on whether the charging point is currently busy or available, but also based on the identity of the user and whether the user is authorised to use the charging point. For example, the user interface may require user login (e.g. with authentication based on username/password or the like), with only registered users permitted to access and use charging points. Additionally, the server may enforce restrictions based on specific charging points available to a given user, particular times at which a user is authorised to access charging points, prepaid account balances etc. User permission information for particular charging points may be stored as control information in the blockchain and/or in the main database.

In one implementation, the system operates a booking system, in which a user can request a reservation for use of specific charging point at a particular time via the user interface. If the reservation is accepted (e.g. based on availability at the requested time, user permissions etc.), the reservation is then recorded in the main database, and an additional data record specifying details of the reservation (e.g. charging point identifier and time period) is written to the blockchain as control information. The client 116 at the charging site then reads the reservation data from the blockchain via the EV Charging server 202 as described above, and activates switch 108 for the time period specified in the reservation.

While in the above-described embodiment, the system is used to control charging of electric vehicles at EV charging points, the invention is not limited to EV charging. In other embodiments, the same system can be used for charging any of type of electric device. For example the system could control charging points provided in public places (e.g. at airports) for charging mobile telephones and other consumer electronics devices (tablet computers, cameras, games consoles etc.)

### Using the Blockchain to Protect Integrity of Transaction Data

In the EV charging application described above, in addition to the control data that is read by the charging site to determine when to activate/deactivate supply of energy via the charging station, the public blockchain 204 also stores integrity validation data, in the form of validation hashes, pertaining to transactions or data records stored in the private database 206. The validation can be used to verify integrity of data in the private database. For example, it allows a user to verify that their energy consumption data has not been altered after the initial creation of the transaction. However, this mechanism is applicable to many different contexts aside from the EV charging application, and will therefore be described in the following section in more general terms.

FIG. 4 accordingly provides a generalized view of the storage architecture employed in the system, illustrating the use of a public blockchain to ensure integrity of a private database. This architecture can be employed in a variety of applications in addition to the EV charging application already described.

In this generalised depiction, the system comprises a data storage controller 400 accessible to an external application or service 406 (e.g. the EV charging server). The external application/service is preferably verified and secured to ensure that only permitted applications/services can access the data storage controller. The data storage controller 400 manages storage of data to a public storage system 402, in the form of the blockchain, and a private storage system 404. Blockchain 402 may correspond to Ethereum blockchain 204 of FIG. 2 and private data storage system 404 may correspond to the BigchainDB 206 of FIG. 2.

External application 406 carries out a transaction, e.g. in response to user input. For example, this could be an EV charging transaction as described above. In another example, described in more detail below, this could be a payment transaction for paying for energy consumption in the home. As part of the transaction, the application invokes a storage operation 408 via the data storage controller 400. In response, the data storage controller writes data to the private storage 404 based on the storage operation. This may involve, e.g. writing a new storage record 410 to the private storage, or updating or deleting an existing record. Additionally, the data storage interface generates a validation record 412 which is written to the public blockchain 402.

In general, the data written to the private and public storage may be the same or different and/or one may include a subset of the other. In a preferred embodiment, the public blockchain is used to enable validation of data held in the private storage. As such, the validation record 412 written to the public blockchain includes some or all of the storage record 410 stored in private storage 404, together with a validation hash.

As an example, in an energy payment application, the external application could generate a payment transaction specifying the following values:
payment date
meter reading
payment amount
payment reference (e.g. from an external payment provider such as a bank or payment service, e.g. PayPal™, confirming successful completion of a payment)

Similar information could be recorded in the EV charging application (e.g. transaction date, amount of electricity used, payment amount and payment reference).

The data storage controller stores the above information as a record 410 in the private storage 404. Additionally the data storage generates a validation hash from the transaction data (i.e. from the four values identified above). It then creates a validation record 412 comprising the validation hash, optionally together with some or all of the transaction data (i.e. one or more of the above values). The validation record is then added to the blockchain as a blockchain transaction. The private storage 404 may include additional data which is not reflected in the public blockchain, such as customer data (e.g. address, energy tariff etc.), aggregate data maintained internally (e.g. account balance) and the like.

The blockchain transaction comprising the validation record is added to the blockchain in the normal manner, i.e. it is added to a most recent block (with each block typically comprising a batch of transactions, which could include multiple validation records and possibly other data), and once full, the block is added to the chain. Addition to the chain occurs via a consensus mechanism requiring consensus from other nodes (typically a majority) participating in the chain. As for conventional blockchains, each block contains a cryptographic hash of the preceding block in the chain. Note that the block hashes used to secure the blocks within the chain are distinct from the individual validation hashes discussed herein which relate to, and can be used to verify, individual transactions with respect to the contents of the private storage. Each block in the blockchain may include multiple validation records 412, each corresponding to an update transaction to the private storage and each with its own validation hash.

Preferably, the blockchain employs a strong consensus mechanism such as proof-of-work (as used e.g. by Bitcoin and Ethereum blockchains), ensuring modification of its contents are trackable and that data on the chain is difficult or impossible to change after being added.

The validation record 412 added to the public blockchain is thus protected from alteration by being part of the blockchain. The inherent immutability of blockchain data gives confidence that the validation hashes stored in the validation record 412 cannot be altered. This in turn allows the data held in private storage to be validated at a later time, by recomputing the hash for a storage record held in the private storage and comparing it to the corresponding validation hash recorded in the public blockchain.

To allow correlation of the storage record 410 in private storage 404, and the corresponding public validation record 412 in the blockchain, both include a unique identifier (e.g. in the given example this could be a payment transaction identifier). This allows the validation record corresponding to a storage record to be retrieved at a later time.

The validation hash can additionally be added to the storage record.

Additional data relating to transactions can also be added to the validation records, in which case the public blockchain can also be used to provide an unfalsifiable record of the transactions that were completed. In one example, the validation record includes the same data as the storage record, together with the validation hash. In another example, only a subset of the storage record is included in the validation record (for example, a customer identifier and payment amount). By careful choice of the data included in the public blockchain, this can be done without exposing sensitive or personal information (e.g. name and address data could be omitted from the validation record). However, for additional protection, the validation records could also be encrypted before adding them to the public blockchain (the storage records in the private storage may similarly be encrypted if needed).

The process in one example implementation can be specified more formally as follows.

Let us denote by l={w1, w2, w3, . . . wk} a subset of information of which we want to guarantee the integrity.

To write l to the storage 404 (e.g. a write operation in the case of a database) the controller:
(i) Computes a hash h(l) of l, and stores l′={h(l), w1, w2, w3, . . . wk} to the private storage 404. In this case, h(l) can be thought of as a key for the table containing the subset of information l in the case of a database.
(ii) Issues a transaction to the blockchain 402 including h(l) as data.

The controller might also populate the storage system with the reference txt_h(l) to the transaction containing h(l).

In one example the hashing algorithm is MD5, but any suitable hashing algorithm could be used to generate the validation hash.

To check the integrity of a subset of information l, the controller retrieves the information l′ from the storage framework, re-computes its hash and compares this with the one stored in the corresponding validation record in the blockchain. Since a change in the data values of the storage record will lead to a different output of the hash function, if there has been a modification, then the re-computed hash value will no longer match the hash value from the blockchain validation record, and thus the system can detect and signal an integrity violation. On the other hand, if the hashes match, the system can assume that the storage record has not been altered (since the validation hash stored in the blockchain can generally be assumed to be unalterable). The system then outputs a validation result for the record being validated (or for a set of such records) to indicate whether the record(s) failed or passed validation.

The ability to perform integrity verification is in principle available to any participant in the system. For example, in the energy payment application example described further below, energy providers can verify information exchanged between providers (e.g. during a customer transfer). Similarly, individual customers, or even unconnected third parties (e.g. regulatory authorities) can check the integrity of data in the blockchain.

Any data stored in the public blockchain could additionally be encrypted (e.g. with a relevant user's key), allowing only that user to read the information. In one approach the data storage interface could use a public key for the user to encrypt the validation record added to the blockchain, making the information readable only by the user, or entities authorised by the user having access to that user's private key.

The private storage 404 may include any type of database, such as a conventional relational database or the like, and could include multiple heterogeneous data sources.

In one implementation, described further below, the private storage 404 is in the form of a second blockchain. In another example, a single blockchain stores both the validation records and the storage records. This is described in the next section.

Single Blockchain with Dual Storage Partitions

In this approach the validation records and storage records are stored on a single blockchain—essentially forming separate “public” and “private” data partitions.

The data of the different partitions is accessed through separate interfaces, and using separate keys. These interfaces are in the form of blockchain smart contracts. The term “smart contract” originally referred to computer protocols for facilitation of electronically managed contracts but is now often more generally used in the context of blockchain technology such as Ethereum to denote any type of code executable on the blockchain. Such code may be used to interact with the blockchain, e.g. by storing data and executable code to the chain, reading data from the chain etc. The terms “contract” and “smart contract” are used here in the latter sense.

In the present implementation, two particular contracts are implemented to provide interfaces to the private and public data partitions. The first interface is provided by a “Storage Contract” which handles storage of private data, corresponding to the private storage 404 of FIG. 4. The second interface is provided by a “Transact Contract” which handles storage of validation records corresponding to transactions and corresponds to the public storage 402. In this case, both types of data are stored in the same blockchain, but via the different interfaces, which can enforce different access permissions.

As in the above examples, the Storage Contract, which manages the private data, is used to store restricted, business critical/operational data structured for throughput and indexed to be used and accessible only by operational entities (e.g. servers under control of the system operator). The Transact Contract is essentially a non-indexed list of transactions stored in chronological order and only contains a subset of data in the Storage Contract, in form of the validation records. The data handled by the Transact Contract is visible to the outside users (e.g. customers) and acts as evidence of transactions in the Storage Contract, allowing integrity validation, possibly with a limited amount of additional data that is exposed to the outside users.

These contracts do not interact directly, but use the storage controller 400 as a conduit to write data to the Storage Contract and Transact Contract. The controller operates using a software SLA (service level agreement) guaranteeing that transactions are pushed through to both contracts, but preferably prioritising the performance of the Storage Contract. In one implementation, the controller 400 writes to both contracts almost instantaneously, however another approach is to write to the Storage contract immediately but to write to the Transact Contract in batches, again through the controller.

The use of smart contracts residing on a single blockchain can allow transparency and high throughput to be achieved.

The operation of the single blockchain implementation will now be described in more detail in relation to a further application example, namely metering and payment processing for domestic or commercial energy users.

A payment platform using this approach is illustrated in FIG. 5. The platform architecture is divided into model, control and view layers.

The model layer is the data access and storage layer. Here, metering platform 502 provides smart meter consumption data for bill calculations. Metering platform includes a relational database storing cumulative consumption data, based on periodically polling connected smart meters (e.g. every 5 minutes). Using the metering platform as intermediary means it is not necessary to store each 5-minute read on the blockchain; instead, data is only written to the blockchain when a payment transaction is carried out. However, alternatively, meter data could be stored directly on the blockchain.

The blockchain stack stores all payment data, account details and tariff details. To execute logic and store data in the blockchain 514, two smart contracts in the form of Storage Contract 510 and Transact Contract 512 are provided, as described above.

For an energy utility use case, the information to be stored typically includes information about billing and other related details; such as connected meter data, consumption data, address, payment history, contact information and tariff details. In this example implementation, all operational data is stored through the Storage Contract, which is optimised for throughput. Additional supporting databases can be used in conjunction with the Storage Contract to support the operational needs.

A subset of information that resides in the Storage Contract is additionally stored in the Transact Contract as means of evidence or method of providing transparency to payment transactions. This subset includes a limited set of data values such as payment amount, date, customer identifier plus a hash of a subset of data from the corresponding Storage Contract transactions (corresponding to the validation record discussed above).

The control layer is the logical layer that executes functions and calculates energy bills. Once consumption data is retrieved, the difference between the latest consumption value and the consumption value at the last payment transaction is obtained. The controller then writes data into the two different contracts, Storage and Transact.

The user interface is rendered in the View layer. Information stored in the blockchain may require certain transformations to allow it to be displayed; once the controller 504 transforms the data, it is sent to the web service 506 to render on user interfaces 508 (e.g. in the form of a mobile device application or web application running in a browser on a user device).

The processing of a payment transaction is illustrated in FIG. 6.

After accessing the payment application and logging into the service (e.g. by providing username/password credentials), the user initiates a payment transaction. In response, in step 602, the controller reads previous payment information to determine a billing period. The Storage contract stores a last payment field which is queried to determine the billing period. This may be in the form of previous payment timestamp which is read from the storage contract. Current consumption data is then obtained from the metering platform 502.

In step 604, the controller then determines the current consumption (total energy consumed), based on the metering records since the last payment time stamp. The controller then calculates a bill amount, by applying an applicable energy tariff (charge rate) to the calculated consumption.

In step 606 a payment view is displayed to the user via the mobile application user interface. The payment view shows the calculated bill together with previous payment history. The interface may provide options for displaying additional bill/consumption details (e.g. usage at different times). The user confirms intention to settle the bill e.g. by selecting a payment button and/or inputting relevant payment details (step 608). In one implementation, payment processing may use one or more external payment providers such as PayPal. In that example, the user would select the relevant payment button for the appropriate payment service, e.g. a PayPal button. The controller then transmits the payment amount together with other relevant information (e.g. user identifier) to the external payment service. This may involve redirection to the payment service, e.g. for user authentication or acquisition of additional payment data. Once the external payment service completes the payment transaction, payment confirmation is transmitted from the payment service to the controller (e.g. via a suitable API) in step 612. The confirmation includes a payment reference (e.g. a PayPal payment reference) confirming completion of, and identifying, the payment.

In step 614, once payment through the payment service is confirmed, the controller writes the necessary billing transaction data to the blockchain. First, the controller commits information through the Storage Contract 510, including customer details (e.g. customer identifier), consumption details (e.g. kWh consumed), payment details (e.g. tariff used and amount paid) together with the payment reference number generated by the payment service. Additionally, the controller then writes a subset of this data to the Transact Contract 512 (as the validation record). The data written to the Transact Contract includes a hash of the record written to the Storage Contract, together with a transaction identifier, and the payment reference number. In one implementation, the two actions occur consecutively and the Storage Contract is prioritised.

FIG. 7 illustrates operation of data retrieval functions. Firstly, a payment history function involves the controller 504 reading previous payment details from the Storage Contract. The controller then formats the information and renders a payment history view 702 within the user interface. Secondly, for an account details function, the controller retrieves account details for a customer from the Storage Contract. The controller then formats the information and renders an account details view within the user interface. The different user interface views could e.g. be screens in the mobile application, web pages etc.

### Contract Structure & Data Storage

One approach to storing data in a blockchain using a smart contract is illustrated by Data Structure 2 shown in FIG. 8, where incoming data objects are stored in a continuous list. This is the approach used in the present implementation for the Transact Contract. However, in this approach, in the event of searching for particular information, e.g. a customers' data and their last payment, it would then be necessary to search the list, retrieve a list of transactions by ‘customer_id’ and then search for the last payment timestamp. In simple example of 4 customers who have all made 4 payments each, a worst case scenario is that the system would have to search through 16 records to find the correct one. This can become a significant issue when there are large sets of transactions in a list with large sets of users.

An alternative approach is to provide a point of interest and the ability to arbitrarily navigate in this point of interest, which can make data access more efficient. This is utilised in the Storage Contract, as illustrated by Data Structure 1 of FIG. 8. Using this approach, payment transactions are aggregated per ‘customer_id’. Inside each ‘customer_id’ object, we store data about the customer as well as a doubly linked list which stores their payment history. Thus, the record for a given customer_id will contain a full set of all payment transactions for that customer. Continuing the previous example, now only 4 rows of would need to be searched, with the last entry under a specified ‘customer_id’ being accessed to obtain the information for their last payment.

Storage records in the Storage Contract and/or transaction records in the Transact Contract may be stored as JSON (JavaScript Object Notation) objects, or in other suitable formats.

As data in the blockchain is immutable, if a record belonging to customer_id is altered (e.g. altering customer data or adding a payment transaction), a new record is created in the blockchain containing a complete updated record. The new altered record will also generate a new validation hash as it is pushed into the blockchain as a new transaction. The blockchain will thus accumulate multiple versions of the record for a given customer_id. From the perspective of using operational data, querying a customer and retrieving their data would simply show the latest version of the data as dictated by data querying methods. The previous ‘states’ can be retrieved from the blockchain by looking for the specific hash of a transaction or searching for a customer's related hashes.

While the Transact Contract could be public (e.g. allowing users to access their records directly without interacting with the energy provider), the Storage Contract is specific to the energy provider, offers a high throughput and is preferably kept in the private domain.

In this implementation, the Storage Contract aims to provide functionalities similar to that of a relational database. In practice, in an Ethereum implementation, the term Storage Contract is used to refer to a collection of smart contracts, referred to herein as pure smart contracts (PSC) (“pure” in the sense that they do not receive or send Ether). In following the analogy with relational databases, a pure smart contract in this setting can act either as a table, a relationship between two or more tables, or both. Like any database management systems, the Storage Contract offers a set of primitives (at the programmer's discretion) for storing and retrieving data items it contains.

One potential drawback of blockchain technology is its transparency and its ability to let participants in the network access any information stored in the network. The Storage Contract addresses this problem by introducing Access Control. Access control is achieved via an application independent PSC (or a set of PSCs) through which the Storage Contract administrator manages users, including granting and revoking access (read, write) to other contracts' functionalities. In other words, the access control PSC defines user roles and controls access to functions or/and procedures implemented by individual PCS. In addition, the access control PSC is itself owned by an account or a set of accounts, in order to ensure its integrity in the public domain. User access control can be enforced by protecting data in the chain using encryption.

The storage contract may need to provide faster transaction throughput and data access and storage of a large amount of data, and may need to interface with other applications of the energy provider. As such, it should preferably be deployed on a faster system as opposed to the transact contract, which is not required to be fast.

Dual Blockchain and Hybrid Implementations

In an alternative implementation, the Storage and Transact Contracts are hosted separately, potentially using completely different storage frameworks. In this approach:
(i) The Transact Contract sits on a blockchain (preferably public) governed by a strong consensus mechanism such as proof of work (PoW), ensuring that any modification on its contents is trackable;
(ii) The storage contract resides on either
   a. a second blockchain (preferably private) governed by a weaker consensus mechanism such as proof of authority (PoA) or proof of stake (PoS); or
   b. a traditional database system allowing data privacy along with high throughput, but low integrity in the sense that there may be limited or no trackable record of data modification

A hybrid storage approach which combines both private blockchains and databases could also be used for the storage contract. This approach corresponds to the one used in the EV Charging application described earlier (which combines a public Ethereum blockchain 204 with a private BigchainDB 206 and SQLDB 208—see FIG. 2).

Thus, in a dual blockchain implementation, the approach described in the previous section is adapted such that the Transact Contract and Storage Contract run on separate blockchains, as illustrated in FIG. 9. Here, the controller 504, Storage Contract 510 and Transact Contract 512 operate essentially as before, but the Storage Contract runs on a first blockchain 902 (e.g. private and using proof-of-authority), whereas the Transact Contract runs on a second, entirely separate blockchain 904 (e.g. public and using proof-of-work). Note that, while the blockchains are separate, it is of course possible for a given computing node to act as a blockchain node for both chains at the same time, and so the storage and transact contract code could in principle also run on the same node, but on different blockchains.

This approach may be more suited to certain applications (e.g. at the enterprise level) where concerns related to data privacy and integrity (due to weak consensus mechanisms), and the need for efficiency (high throughput) and reliable internal processes may make the single blockchain approach unsuitable.

The use of a weaker consensus mechanism (e.g. PoA or PoS) for the private storage blockchain (Transact Contract) can improve throughput since less processing is needed to add blocks to the chain. At the same time, the stronger consensus mechanism (PoW) used on the public blockchain ensures the integrity of the transaction data stored there, in particular the validation hashes stores as part of validation records, and this in turn can help ensure the integrity of the data in the private storage blockchain (Storage Contract), despite the weaker consensus mechanism and thus theoretically less robust inherent integrity of the latter.

In an implementation using a conventional database (instead of a second blockchain) for the private storage, the database may use any suitable database technology or combination of technologies. Thus, the private storage system may in that case include a relational database, or a non-relational or NoSQL database, such as an object database, a column-oriented database, a document-oriented database, a key-value store or a graph database.

### Provider Switching

As described previously, the validation hashes stored to the public blockchain allow the user, system operator (e.g. an energy provider) or a third party to validate data in the private storage. This section describes a specific use case of this approach, focusing on the process of a user switching energy providers, which without loss of generality consists of an actor unsubscribing with a given provider (e.g. energy supplier) and subscribing to another provider (e.g. energy supplier). This is generally motivated by the need of a better quality of service, cheaper prices, etc.

At present, when switching energy providers it typically takes a minimum of 20 days (and in worst cases over 6 months) to verify switching which is inefficient and detrimental to customer experience. The present techniques allow data to be transferred between energy providers and then verified automatically and efficiently, allowing switching times to be reduced substantially.

In this scenario, an actor A is switching from energy supplier ES1 to supplier ES2. We make the following assumption:
(i) Actor A is linked to a smart meter asset maintained on an asset registry shared by and accessible to both providers;
(ii) Each supplier maintains various information on actor A, including A's payment history;
(iii) A's payment history should be transferred by the current provider ES1 to the new supplier ES2 when a switch happens. This must be done by supplier ES1 because the full payment history can only be found on ES1 storage contract (private blockchain or database);
(iv) A payment is a sequence of information of the form l={w1, w2, w3, . . . wk}.

Supplier ES2 wishes to check that the information it is receiving from ES1 is the correct record. This is to ensure that settlement debt or billing lifecycle is handed over correctly from one energy company to another when the customer switches, there being no physical cutoff between leaving one provider and starting with another. Furthermore, ES2 may wish to confirm whether A's payment history record has been tampered with or altered in any way. The storage architecture described previously can be used to solve these problems as follows.

Each provider has its own private storage (which could be a traditional database or a private blockchain), and can access the public blockchain (governed by proof of work) via a suitable storage interface (e.g. the previously described storage controller and/or Transact Contract).

Every time A makes a payment to ES1, the control layer performs the following operations:
(i) Store the payment in ES1's private storage (database or private chain);
(ii) Compute the validation hash (e.g. MD5) of the payment transaction and issue a transaction on the public blockchain with the corresponding validation hash, ultimately storing it on the chain, and retrieve the id of the transaction;
(iii) Update ES1's internal storage with the id of the new transaction.

At the point of transfer, ES1 transfers customer data including the payment history to ES2. To verify the integrity of A's payment history, the control layer on behalf of ES2 runs the following algorithm:
For each payment P by A to ES1:
   (i) Compute the validation hash (e.g. MD5) of P;
   (ii) Retrieve the corresponding validation hash from the public blockchain using the stored transaction id;
   (iii) Compare the retrieved validation hash to the one computed and return FALSE if they do not match.
Return TRUE

The algorithm returns TRUE when A's payment history has not been tampered with, and ES2 can be confident in the authenticity of the information it received from ES1. Note that the actions attributed to ES1 and ES2 in the above description are carried out by computer systems associated with the respective energy supplier. ES2's computer system can perform the process described to automatically validate transferred records upon receipt as part of the switching process.

To improve the algorithm's efficiency, one can limit the number of checks to the last few months, weeks, etc.

As the above example illustrates, multiple energy providers—or indeed organisations or entities of any kind—can thus utilise the described storage architecture to enable reliable cooperation—provider switching is just one example of such cooperation between separate entities.

Each organisation or entity may maintain private data using any suitable storage framework (e.g. blockchain, relational database etc.) which may differ between organisations, whilst at the same time writing validation hashes of privately stored data, together with any data that is to be made available directly to customers or other organisations, to a single shared or public blockchain. Organisations can then validate integrity of each other's information by use of the publically recorded validation data (validation hashes).

A related example where the above approach may be useful is industry settlement (e.g. to ensure correct settlement between various energy providers and/or network operators). This is illustrated in FIG. 11. In this example, energy provider A operates various internal functionality, including processing of transactions relating to energy supply/consumption. Transactions are stored in Provider A's private storage (here termed a “throughput ledger”) with validation data stored to a public blockchain (here termed the “integrity ledger”). As shown, other providers such as Provider B may operate their own integrity ledgers (as well as their own private storage e.g. throughput ledgers, not shown). Alternatively, a shared integrity ledger could be used by multiple providers. The integrity ledgers can be used to validate information held by providers as discussed previously. Validation can be performed by energy providers and other industry parties, in this example distribution network operators, distribution system operators and regulatory authorities such as UK energy regulator OFGEM.

### Home Energy Management Extensions

The described approach to using blockchain for storing and processing energy consumption data can be extended to support advanced home energy management functionality. For example, the system described with respect to FIGS. 5 to 7 can be extended to support consumption by a consumer (e.g. household) from multiple consumption sources, including (possibly multiple) grid providers and/or local generation assets, such as local solar generation or battery storage.

Consuming from local assets is similar to consuming from a supplier in a sense that at a high level, they could provide a similar set of data points and be implemented as a supplier in a smart contract. To support these extensions, the definition of a “supplier” can be abstracted and stored in several smart contracts, as illustrated by way of example in FIG. 12. At a high level, a smart contract for a supplier (e.g. “consumption_source” contract 1202) would define supplier identity information and other metadata. Additional supplier related smart contracts can then be implemented as layers with more details specific to the type of consumption source they represent. In the FIG. 12 example, this is in the form of a hierarchical structure in which “local_assets” smart contract 1204 comprises specific smart contracts for different individual assets 1206, 1208, 1210, and “grid_supplier” smart contract 1212 is in turn associated with individual smart contracts 1214, 1216 for different energy suppliers from whom the consumer may consume energy.

The depicted hierarchy of smart contracts may exist within the previously described storage contract for storing consumption data as depicted in FIGS. 5-7. Thus, by way of example, the arrow labelled “A” in FIGS. 6 and 12 illustrates attachment of the hierarchy of contracts of FIG. 12 to the storage contract 510 of FIG. 6 which then forms the highest level of the contract hierarchy. The FIG. 6 process may then use information from the various smart contracts in determining consumption and cost data and performing the other described processing for different consumption sources. The processing may be applied individually to each consumption source using its respective smart contract and may be performed for all or selected sources. Consumption and cost/payment data may also be aggregated across sources as appropriate.

Note that in the case of local energy generation (e.g. through solar generators) there is also the possibility that the consumer (e.g. a household) may supply energy back into the distribution grid (e.g. if producing more energy from local assets than is being consumed at a given time). To this end, the smart meter for the consumer and associated metering platform may also be able to record energy flowing to the grid from the energy customer (e.g. from a particular house/building), in addition to energy consumed from the energy grid. This may then be used in settlement (e.g. offsetting supply against consumption, crediting the customer etc.).

In the case of supplier switching, the data transfer and validation functions can also be replicated across different consumption sources or applied to specific selected consumption sources by use of the relevant smart contracts.

In the above examples, the different storage domains were described as “public” and “private” respectively (e.g. public blockchain 402 and private storage 404 of FIG. 4). This distinction is made to allow clear understanding of typical use cases, but is not essential. For example, as indicated above, even though the information on the public blockchain may be public in the sense that any Internet-connected computer can join the chain, it may be encrypted such that only users with relevant keys can read the information (e.g. the customer to whom a transaction pertains, the energy provider, other energy providers, regulatory bodies etc.) Use of the blockchain can nevertheless ensure integrity of the information because the blocks (and hence the validation records they contain) cannot easily be altered after creation. In principle, the private storage could similarly be a public blockchain, but with access to the data limited to the specific organisation or entity (energy provider).

More generally, in different applications, either storage domains may be public or private and data may or may or not be protected by encryption/user access control. The blockchain used for validation will however generally provide a sufficiently robust consensus mechanism (e.g. proof of work) such that manipulation of the validation records is difficult or impossible after creation, whilst the “private” storage domain may have a weaker consensus protocol (in the case of a blockchain) or weaker/no inherent integrity protection (in the case of other storage frameworks, e.g. relational databases). The “public” blockchain may also typically not be under the control (or under the sole control) of the owner of the “private” data storage domain. The “private” storage domain or blockchain may in many cases be optimised for throughput/performance, while the “public” blockchain may typically be optimised for security/integrity.

### Processing Node

FIG. 10 illustrates a processing node 114 which may be used to implement functionality described above, e.g. in the form of a computer server. The server includes one or more processors 1002 together with volatile/random access memory 1004 for storing temporary data and software code being executed.

A network interface 1008 is provided for communication with other system components (e.g. connected switch 108, metering platform 112, and/or user devices 116 of FIG. 1) over one or more networks (e.g. Local or Wide Area Networks, including the Internet).

Persistent storage 1006 (e.g. in the form of hard disk storage, optical storage and the like) persistently stores software modules for execution by the processor(s), for performing the described functions, including a storage controller module 1010 for implementing functions of e.g. controller 400/504 previously described, database server module 1012 for implementing one or more private databases, and an Ethereum node module 1014 for participating in the distributed Ethereum blockchain and reading/writing to/from the chain. Additionally, a request server module 1016 may implement functions for interacting with external systems/application (e.g. this may correspond to EV charging server 202 of FIG. 2). The persistent storage also includes other server software and data (not shown), such as a server operating system.

The server will include other conventional hardware and software components as known to those skilled in the art, and the components are interconnected by a data bus (this may in practice consist of several distinct buses such as a memory bus and I/O bus).

While a specific architecture is shown by way of example, any appropriate hardware/software architecture may be employed.

Furthermore, the functions of server node 114 may in practice be implemented by multiple separate connected processing devices. In particular, the software modules 1010, 1012, 1014 and 1016 may be distributed across any number of different devices which may be locally connected or remotely connected, e.g. via the Internet.

It will be understood that the present invention has been described above purely by way of example, and modification of detail can be made within the scope of the invention.

1. A method of securing data stored in a data storage system using a blockchain, wherein the data storage system is separate from the blockchain, comprising:
receiving, at a storage interface, data to be stored in the data storage system;
computing validation data for validating integrity of the data;
creating a storage record comprising the data and writing the storage record to the data storage system; and
creating a validation record comprising the validation data and writing the validation data to the blockchain.

2. The method according to claim 1, wherein the computing step comprises computing a hash value based on the data, the validation data comprising the hash value.

3. (canceled)

4. (canceled)

5. The method according to claim 1, wherein the data storage system comprises a second blockchain, separate from the blockchain, wherein the blockchain uses one of: a different, preferably stronger, consensus mechanism than the second blockchain; and a consensus mechanism not based on proof-of work, preferably based on proof-of-stake or proof-of-authority.

6. (canceled)

7. (canceled)

8. The method according to claim 5, wherein the blockchain and the second blockchain comprise respective interfaces for storage of data, each respective interface comprising code executable by the respective blockchain, preferably in the form of one or more smart contracts operating on the blockchain.

9. The method according to claim 1, wherein the data storage system comprises a database system, optionally comprising one of a relational database, a non-relational or NoSQL database, an object database, a column-oriented database, a document-oriented database, a key-value store or a graph database.

10. The method according to claim 1, wherein the blockchain is a public blockchain, preferably wherein the data storage system is not public and/or wherein the validation records in the blockchain are accessible to one or more users not having access to the data storage system.

11. (canceled)

12. A method of storing data in a blockchain, comprising:
receiving, at a storage interface, data to be stored in the blockchain;
computing validation data for validating integrity of the data;
creating a storage record including the data and writing the storage record to the blockchain using a first interface of the blockchain; and
creating a validation record including the validation data and writing the validation record to the blockchain using a second interface of the blockchain.

13. (canceled)

14. The method according to claim 12, wherein the first and second interfaces comprise one of: respective code executable by the blockchain; and one or more respective smart contracts operating on the blockchain.

15. (canceled)

16. The method according to claim 12, wherein access to the first and second interfaces is controlled based on respective first and second access permissions, wherein the second storage interface allows access to validation records by one or more users in accordance with the second access permissions where said users are prevented from accessing the first storage interface in accordance with the first access permissions; optionally wherein the blockchain comprises a smart contract for managing the access permissions.

17. (canceled)

18. (canceled)

19. The method according to claim 1, wherein the storage record further includes the validation data.

20. The method according to claim 1, comprising at least one of: adding a transaction identifier to the validation record identifying the corresponding storage record; and adding a common transaction identifier to the storage record and validation record.

21. (canceled)

22. The method according to claim 1, wherein the storage record comprises a plurality of data elements, the method comprising adding one or more, but preferably not all, of the data elements of the storage record to the validation record.

23. The method according to claim 1, comprising encrypting one or both of the storage record and the validation record before storage, optionally using different encryption keys.

24. The method according to claim 1, comprising processing an energy supply transaction, wherein the received data relates to the energy supply transaction; wherein the data comprises one or more of: an identifier of an energy consumer; an energy consumption value indicating an amount of energy consumed by the energy consumer; a payment amount and a payment reference.

25. (canceled)

26. The method according to claim 24, wherein processing the energy supply transaction comprises:
obtaining consumption data specifying energy consumption by an energy consumer;
determining a consumption value based on the consumption data and optionally based on past payment transaction data for the energy consumer; and
creating payment transaction data based on the consumption value;
wherein the data to be stored comprises the payment transaction data.

27. (canceled)

28. The method according to claim 1, comprising validating the storage record by a process comprising:
retrieving the storage record including the stored data;
re-computing the validation data from the stored data;
retrieving the validation record corresponding to the storage record from the blockchain;
comparing the re-computed validation data to the validation data in the retrieved validation record; and
outputting a validation result in dependence on the comparison.

29. A method of validating a storage record, comprising:
retrieving the storage record including stored data from a first storage domain;
computing validation data from the stored data;
retrieving a validation record from a second storage domain, the second storage domain comprising a blockchain, wherein the validation record comprises validation data previously computed for the storage record;
comparing the computed validation data to the validation data in the retrieved validation record; and
outputting a validation result in dependence on the comparison.

30. The method according to claim 29, comprising outputting a validation error if the re-computed validation data does not match the validation data in the retrieved validation record and/or outputting a successful validation indication if the re-computed validation data matches the validation data.

31. The method according to claim 1, further comprising:
transferring a plurality of storage records from a first entity to a second entity, the first entity having stored the storage records in a storage domain under control of the first entity and not accessible to the second entity, the storage domain comprising the data storage system, the first entity further having stored validation records corresponding to the storage records in the blockchain, the blockchain accessible by both the first and second entities;
retrieving, by the second entity, the validation records corresponding to the transferred storage records from the blockchain; and
validating, by the second entity, the transferred storage records using the retrieved validation records.

32. (canceled)

33. (canceled)

34. The method according to claim 31, wherein the first and second entities comprise respective first and second computer systems associated with respective first and second energy providers, and wherein the transfer and validation is performed by the second computer system associated with the second energy provider in response to a transfer of an energy consumer from the first energy provider to the second energy provider.

35.-61. (canceled)
